(19) United States
(12) Patent Application Publication
(10) Pub. No.: US 2020/0202008 A1
(43) Pub. Date: Jun. 25, 2020

(54) COLLECTION OF PLC INDICATORS OF COMPROMISE AND FORENSIC DATA

(71) Applicant: Siemens Aktiengesellschaft, Munich (DE)

(72) Inventors: Leandro Pfleger de Aguiar, Robbinsville, NJ (US); Dong Wei, Edison, NJ (US); Stefan Woronka, Baddeckenstedt (DE)

(21) Appl. No.: 16/613,211

(22) PCT Filed: May 24, 2017
(86) PCT No.: PCT/US2017/034128

§ 371 Date: Nov. 13, 2019

(51) Int. Cl. G06F 21/57; G06F 11/30; G06F 11/34

(52) U.S. Cl. CPC G06F 21/577; G06F 2221/034; G06F 11/3485; G06F 11/3041

(57) ABSTRACT

The present embodiments relate to monitoring and analyzing programmable logic controllers (PLC) for security threats. By way of introduction, the present embodiments described below include apparatuses and methods for non-intrusive monitoring and forensic data collection for PLCs. Security monitoring and forensic applications are provided to perform secure collection, compression and export of PLC information. The security monitoring and forensic applications collect data indicative of low level PLC data and operations, and a forensic environment is provided to analyze the PLC data and operations and to perform forensic simulations.

### BACKGROUND

There is increased interest by cyber attackers in attacking critical infrastructure by compromising industrial automation and control systems. Due to vertical integration of the production systems and horizontal integration of the value chain, industrial control systems (ICS) and industrial control networks are often directly or indirectly connected to information technology (IT) networks, such as local office and plant networks and the Internet. This vertical integration may provide an opportunity for cyber attackers to exploit those networks to take advantage of known and newly discovered infrastructure vulnerabilities.

Unlike computers and other computing devices running on conventional IT networks, many currently deployed ICS products (e.g., programmable logic controllers (PLCs), distributed control systems (DCS), motion controllers, supervisory control and data acquisition (SCADA) systems, and human-machine interfaces (HMIs) were designed for process control functionalities without, in many cases, intrinsic consideration of cybersecurity. Most process control system networks, including multiple PLCs, DCS devices, motion controllers, SCADA devices and HMIs, are also integrated without consideration for potential cyber threats.

Typical security solutions for industrial control systems are based on production cells and devices being isolated from accessible networks, preventing cyber-attackers from accessing critical systems. FIG. 1 illustrates an example of protecting a PLC from cyber-attacks using network isolation. For example, FIG. 1 depicts a segmented architecture with five production cells on a plant floor level. The network for each production cell is isolated from others and protected by network isolation (e.g. a firewall or Virtual Private Network (VPN)). This solution is based on an assumption that cyber-attacks always originate from the outside world (e.g., a communication link between a production cell network and an office network). Cyber-attacks and other malicious software have been successful in targeting industrial control systems despite the isolated networking.

Further, industrial control systems may require data to be exchanged with business and external production management systems via intranet and Internet networks. Another current security solution for industrial control systems is based on purely reactive security counter-measures. Detection and investigation of each threat is performed after a security event by the security experts analyzing the affected system. A combination of manual steps, code reverse engineering, and dynamic malware analysis (e.g., by observing malware behavior, etc.) is performed. Especially for Industrial Control Systems, manual code reverse engineering is heavily utilized, depending on a team of security experts to read large amounts of code under pressure conditions.

### SUMMARY

The present embodiments relate to monitoring and analyzing programmable logic controllers (PLC) and adjacent systems for security threats. By way of introduction, the present embodiments described below include apparatuses and methods for non-intrusive monitoring and forensic data collection for PLCs. Security monitoring and forensic applications are provided to perform secure collection, compression and export of PLC information. The security monitoring and forensic applications collect low level PLC relative to process data and to the PLC functions, and a forensic environment is provided to analyze this data and to perform forensic simulations.

In a first aspect, a method of monitoring a programmable logic controller (PLC) is provided. The method includes extracting and storing security relevant PLC data and PLC process data by a forensic environment from a monitoring application installed on the PLC, and analyzing the PLC security data and the PLC process data. The method further includes determining a security event of the PLC based on the analyzing, and initiating forensic data collection for the PLC by the forensic environment via a PLC forensics application (after-the-fact). The method also includes collecting forensic data (e.g. security events) from the PLC and storing the forensic data in a forensically sound manner (e.g., preserving the chain-of-custody) for subsequent processing in the forensic environment by a PLC forensics application.

In a second aspect, a system for monitoring programmable logic controller (PLC) operations is provided. The system includes a memory configured to store a security monitoring application and a security forensics application and a processor. The processor is configured to execute the security monitoring application to collect data indicative of PLC operations and to execute the security forensics application to perform non-intrusive forensic evidence collection.

In a third aspect, another method of performing forensics on a programmable logic controller (PLC) is provided. The method includes defining a plurality of PLC operations for monitoring, where the plurality of PLC operations are indicative of a security event. The method further includes monitoring the plurality of PLC operations, process data and PLC status of a live PLC by collecting live production data representative of the plurality of PLC operations, process data and PLC status, and analyzing the data for the security event. The method includes detecting and/or validating the security event for the live PLC and deploying forensic data collection for the live PLC in response to the detected security event. Forensics is performed on the live PLC by emulating the expected behavior of the live PLC and comparing the expected behavior of the live PLC to the actual behavior of the live PLC.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the Figures are not necessarily to scale, emphasis instead being placed upon illustrating the principles of the embodiments. Moreover, in the Figures, like reference numerals designate corresponding parts throughout the different views.

FIG. 1 illustrates an example of a prior art solution for protecting a PLC from cyber-attacks.

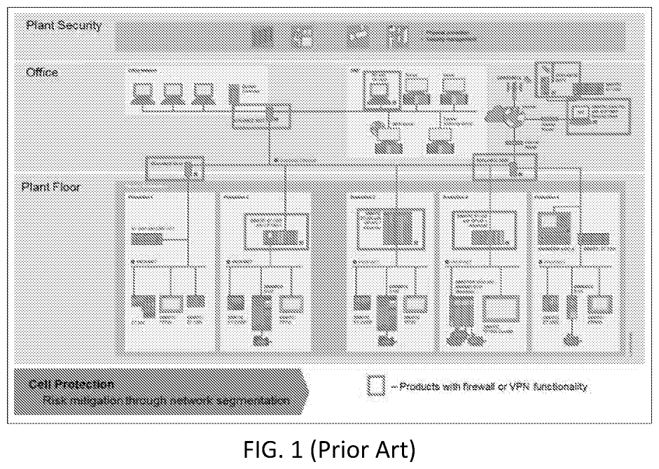

FIG. 2 illustrates a flowchart diagram of an embodiment of a method of monitoring a PLC.

FIG. 3 illustrates an example of deployment modes for monitoring a PLC.

FIG. 4 illustrates an example of monitoring a PLC.

FIG. 5 illustrates a flowchart diagram of an embodiment of another method of monitoring a PLC.

FIG. 6 illustrates an embodiment of a system for monitoring a PLC.

### DETAILED DESCRIPTION OF EXEMPLARY EMBODIMENTS

Forensic analysis on PLCs is performed to understand, analyze and respond to cyber-attacks and other security incidents targeting industrial control systems. Due to the lack of specialized tools or PLC architectures facilitating data collection (e.g., potential indicators of compromise), data collection is often a daunting task for forensics investigators and/or security experts. Further, without specialized tools or PLC architectures for collecting PLC data for understanding Tactics, Techniques, and Procedures (TTPs) of a cyber-attack, forensics investigators and security experts might take weeks or even months until security incidents are addressed.

The present embodiments provide for quickly and securely collecting and extracting forensic data from PLC devices in a distributed industrial control system network. The present embodiments may instrument a PLC software stack and hardware prior to the attack to rapidly detect cyber-attacks, such as advanced persistent threats (APTs) and other malicious software and security threats. The instrumentation provides new ways to detect cyber-attacks by monitoring the PLC before the cyber-attack, ways of reducing and/or minimizing the adverse impacts of the cyber-attack on an industrial control system, and ways of reducing and/or minimizing the time and complexity of performing forensic analysis on the industrial control system. Additionally, dynamic forensic analysis may be performed safely on a running (e.g., live) production environment, helping to detect cyber-attacks instantly and to initiate corresponding counter-measures, hence avoiding costly down-time for the industrial control system. For example, a forensics infrastructure is provided as a collection of virtual and physical systems that aggregate historical production data and utilize the computing power and storage of the collection of systems to facilitate historical comparisons based on aggregated production data.

The present embodiments provide systems and methods for monitoring and performing forensic analysis of programmable logic controllers (PLCs). For example, the systems and methods deploy and/or utilize one or more modes of PLC forensic instrumentation to monitor PLCs and execute forensics in the event of a security event. For example, a controller (e.g., PLC) or another device (e.g., industrial personal computer) is instrumented such that low level tracing of PLC functions is monitored and recorded. Executed PLC code and other PLC operation is monitored and recorded at different levels, such as at the firmware, operating system and/or application levels. A security monitoring application provides for non-intrusive and secure collection, compression and exporting of PLC information for forensic use (e.g., security monitoring data, indicators of compromise, indicators of attack, etc.). A security forensics application is deployed after a security event is confirmed/validated (e.g., a security breach, cyber-attack, etc.). The security forensics application facilitates non-intrusive forensic evidence collection (PLC operations, process data and PLC status), preserving the chain-of-custody for the forensic information. The security forensics application also facilitates non-intrusive collection of live process data.

Using data received from security monitoring and forensics applications, a centralized forensics portal application (e.g., running out of a secure operations center—SOC) environment in a forensics runtime environment is provided for forensic analysis for the industrial control system. The centralized forensics portal application may also make requests to the security monitoring application (e.g., requests for additional or different data). For example, the forensics portal application performs forensic analysis on live industrial control systems by leveraging live production data, thereby enhancing the security and forensic analysis. The forensics portal application also uses a combination of real world collected data and a virtual runtime environment (e.g., a sandbox) to analyze malicious applications. The forensics portal application also includes big data storage and an analytics infrastructure for fleet level benchmarks, historical trend analysis and data enrichment based on data recorded and received from many different industrial control systems.

By providing for automated collection PLC information (e.g., security monitoring data, indicators of compromise, etc.) and forensic analysis, cybersecurity of the PLC and other devices of an industrial control system may be improved, such as by detecting intrusions and malicious changes, performing remedial measures, and thus shortening the time and effort required for forensics analysis. For example, a PLC is provided with new monitoring and forensics applications (e.g., runtime technology allowing for security applications to run on a PLC device) that upload PLC information to a cloud-based forensics portal application for analysis. In another example, an industrial personal computer (IPC) is provided with the new monitoring and forensics applications (e.g., a ruggedized PC for collecting PLC and other process information). Alternatively, an existing PLC is modified to execute the new monitoring and forensics applications (e.g., via injectable firmware code installed on the PLC). Additionally, a combination of a new PLC, an industrial PC and/or a modified PLC may be provided with the monitoring and forensics applications. Data is collected and analyzed in real-time to detect potential cyber-attacks. The live data may also be used in a live PLC emulation to stimulate and eliminate dormant cyber-attacks.

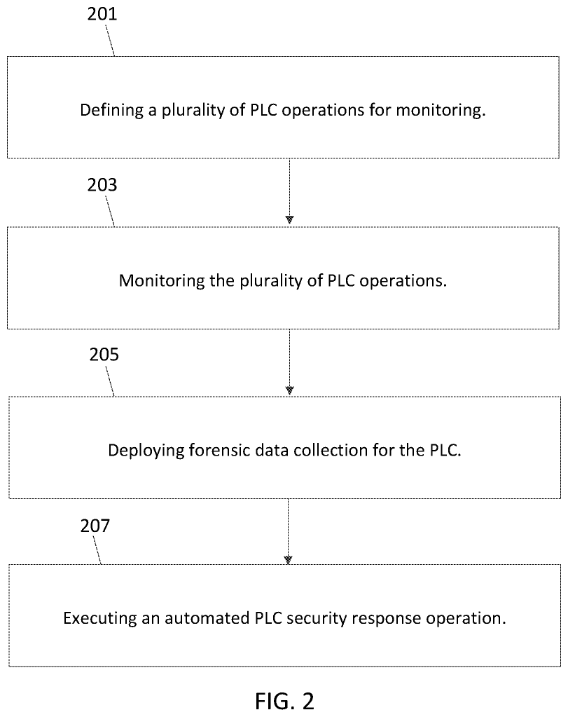

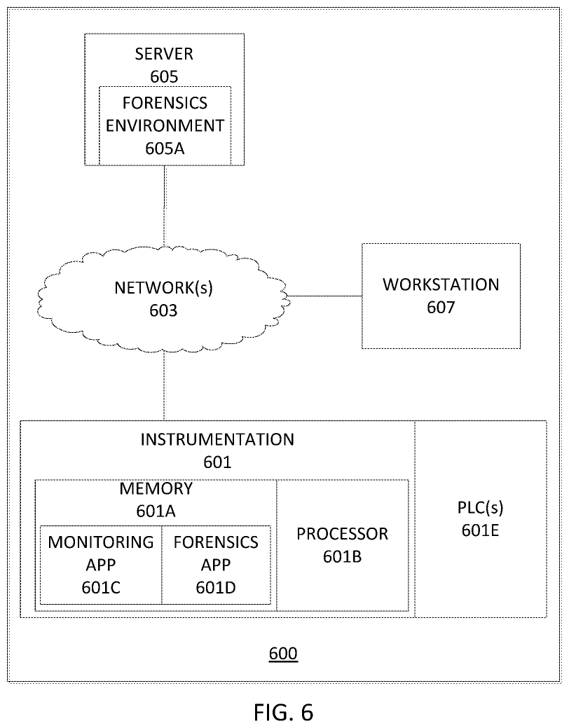

FIG. 2 illustrates a flowchart diagram of an embodiment of a method of monitoring a programmable logic controller (PLC). The method is implemented by the system of FIG. 6 (discussed below) and/or a different system. Additional, different or fewer acts may be provided. For example, the acts 205 and 207, in FIG. 2, may be omitted. The method is provided in the order shown. Other orders may be provided and/or acts may be repeated. For example, acts 205 and 207 may be repeated for a plurality of security events. Further, acts 203, 205 and/or 207 may be performed concurrently as parallel acts.

At act 201, a plurality of PLC operations and/or PLC data points are defined for monitoring. For example, a plurality of PLC operations and data points that may be indicative of a security event are selected. Operations, process data points and PLC status from multiple PLCs may be defined, and relationships between the operations and data points from multiple PLCs may be used to determine whether a security event occurs.

In an embodiment, the PLC operations and PLC data points are indicators of compromise (IoCs). The term “indicator of compromise” refers to “an artifact that is left on a system or network that signifies a known threat of attack has occurred.” (Fowler, Kevvie, “Data Breach Preparation and Response: Breaches are Certain, Impact is Not,” Syngress, 2016). For example, operations and process data are defined to monitor a system or network for traces of payloads or other signs of the particular exploit used in an attack. Additionally, indicators of attack (IoA) may also be defined. IoAs are defined for monitoring a system or network for traces of activity seen after the system is exploited. IoCs used in information technology (IT) networks include virus signatures, internet protocol (IP) addresses, malware file hashes, malicious URLs, malicious domain names, etc. Other IoCs may be defined and monitored.

In an embodiment, IoCs for an industrial control system are defined to include PLC-based indications. Any PLC operation, process data or PLC status may be defined as a PLC IoC. For example, PLC IoCs may include one or more of the following: an organization block for cyclic program processing (OB1) and other time-driven organization blocks (OBs); PLC memory operations and usage; round-trip communication time of data packets on different communication channels (e.g., Ethernet, field buses, etc.); inbound/outbound communication patterns; associated internal implications of inbound/outbound communication patterns (e.g., real-time operating system (RTOS) established network socket to network connection identifiers); IP addresses of the communication partners (e.g., other computers and devices in the industrial control system); PLC block read and write patterns; newly downloaded or executed PLC blocks (e.g., organization blocks (OBs), function blocks (FBs), functions (FCs), system function blocks (SFBs), system functions (SFCs), data blocks (DBs), and system data blocks (SDBs)); file upload and download operations; firmware read/write operations; security specific log operations (e.g., authentication, encryption, decryption, etc.); utilization patterns within the PLC architecture (e.g., input/output (I/O) response times, cache utilization, driver loading and operation utilization times, timers access and utilization patterns, application loading/unloading, exception handling operations, interrupts utilization patterns, filesystem access patterns, etc.); bootstrap operations and boot chain sequence; violated security verifications (e.g., signature of online blocks, etc.); and other selected key performance indexes of production process data (e.g., sensor data, such as temperature, pressure, current, velocity, position, etc., production rate, energy consumption, etc.). The aforementioned list of PLC IoCs is exemplary, and other PLC IoCs may be defined and monitored.

At act 203 in FIG. 2, a plurality of PLC operations, process data and/or PLC status are monitored. For example, monitoring includes collecting data representative of the plurality of PLC operations and other process data from the PLC. Monitoring also includes analyzing the collected data for and detecting a security event. Monitoring a PLC may be performed by one or more devices, such as by applications running on the PLC, by applications running on a separate/neighboring PLC, and/or by applications running on separate/neighboring device, such as by an industrial personal computer (IPC) configured to collect PLC data.

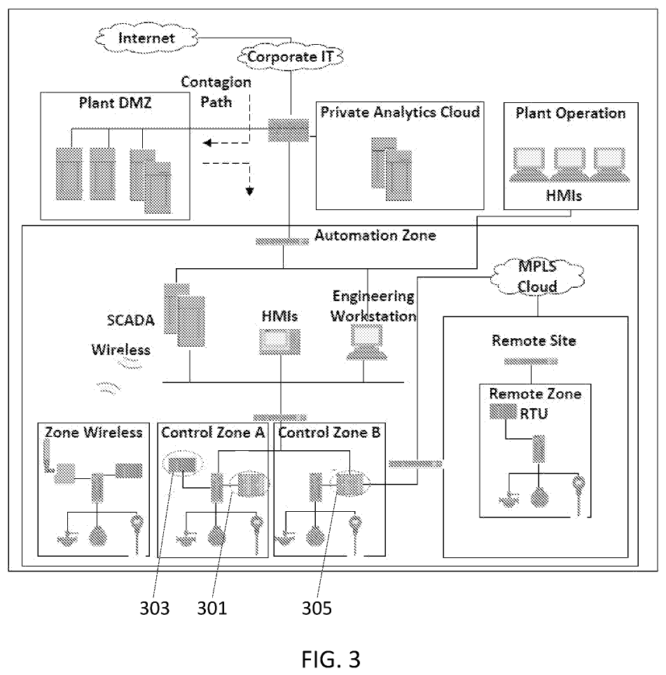

FIG. 3 illustrates an example of deployment modes for monitoring a PLC. One or more of the deployment modes may be used for green field deployments (e.g., new industrial control systems) or brown field deployments (e.g., existing or legacy industrial control systems). FIG. 3 depicts three examples of deployment modes: mode 301; mode 303; and mode 305. Additional deployment modes may be used, and deployment modes may be combined to monitor a plurality of PLCs in a production/control zone or across multiple production/control zones. In each deployment mode, monitoring the plurality of PLC operations and/or PLC process data includes monitoring PLC firmware, PLC operating systems and PLC applications.

In deployment mode 301, a new PLC is deployed with a runtime environment that supports the deployment and execution of security applications during a live production process. In an example, the new PLC is provided to perform production process operations (e.g., executing PLC code) and security operations (e.g., executing security and forensics applications) in parallel while the process is running. In deployment mode 301, the security monitoring and forensics applications running on the PLC are configured to monitor the PLC and neighboring devices (e.g., legacy PLCs), providing forensics and security monitoring functions that cannot be supported or executed on the neighboring devices due to computational power or memory space limits. The runtime environment natively supports high fidelity process history storage (e.g., an embedded historian), data compression, and short-term analytics.

In deployment mode 303, an industrial personal computer (IPC) is deployed with monitoring and forensic applications installed. The IPC is deployed locally at a control zone network segment (e.g., control zone A) where devices to be monitored reside (e.g., neighboring devices, such as legacy PLCs). The IPC also natively supports high fidelity process history storage (e.g., an embedded historian), data compression, and short-term analytics.

In deployment mode 305, an existing PLC device is modified to execute monitoring and forensic applications. For example, a modification is performed on an existing PLC (e.g., low level firmware, operating system and/or software modifications), providing for security applications to be executed by the device. In an implementation, security monitoring and other processes are implemented as injectable firmware or application code installed on the PLC device. PLC data is monitored and recorded by the injectable firmware or application code, and the data may be analyzed for a security event or provided to a software application to evaluate the data for possible threats to the industrial control system.

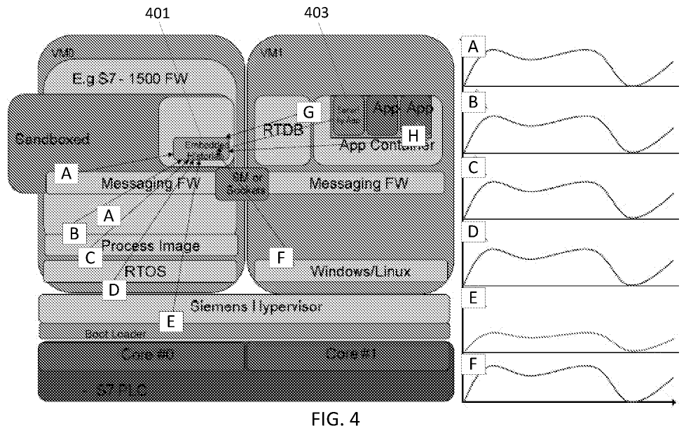

FIG. 4 illustrates an example of monitoring a PLC. FIG. 4 depicts monitoring a PLC using deployment mode 301 of FIG. 3. FIG. 3 depicts a layered architecture for monitoring security data points and operations of the PLC and for continuous collection of data indicative of the defined PLC IoCs. The monitored PLC operations and process data are stored in the embedded process historian 401.

As depicted in FIG. 4, multiple process data points and PLC status from the PLC are monitored and analyzed to identify an IoC of the PLC. For example, the following process data points and PLC status from the layered architecture are monitored: PLC firmware (FW) A (e.g., messaging firmware); PLC process image B (e.g., the inputs (PII) and outputs (PIO) stored in the CPU system memory of the PLC); runtime operating system (RTOS) C; Siemens Hypervisor D (e.g., the runtime environment for the PLC supporting the monitoring and forensics applications); boot loader E; Windows/Linux application F; runtime database (RTDB) G; and PLC applications H. Referring to the data graphs for A-F, analysis of PLC data may compare data from the different PLC layers to identify a potential security event. As depicted in FIG. 4, the graph for the boot loader data E is inconsistent from the data for the other monitored data points A-D and F. As such, the inconsistent data from the boot loader E may be indicative of a security event. In other embodiments, inconsistency of the data point with itself over a period may indicate a security event.

In an embodiment, monitoring the plurality of PLC operations and/or PLC data points is performed by a security monitoring application. For example, depending on the deployment mode (as discussed above), the security monitoring application may be executed by the PLC, by a neighboring PLC, by an industrial PC, or by another device. Referring to FIG. 4, the security monitoring application 403 is executed by application container of the PLC.

The security monitoring application collects data at the different monitoring points and continuously saves the data to an embedded process historian in high fidelity (e.g., high frequency forensic data points). The security application may be deployed prior to potential security events (e.g., in high security risk environments) to allow for detailed forensic data extraction prior to, during and after a security event. The security monitoring application continuously collects data at different layers of the PLC architecture (e.g., firmware, OS and application layers), enabling the security monitoring application to perform continuous forensic analysis by leveraging short term analytic functions. For example, the security monitoring application performs comparisons that correlate data from the different layers of the controller architecture and check for consistency in the data.

Examples of the continuous analytic functions include data provenance analysis, alert notifications, volatile evidence preservation, etc. Additional analytic functions may be implemented. Data provenance analysis continuously tags data at the data generation point (e.g., at the I/O write/read process function call, and data blocks from other devices, such as other PLC, HMI and MES) to track the malicious manipulation of data or false data injection. Alert notification (e.g., for critical changes) continuously monitors system variables (e.g., critical system variables, such as cycle-time, system clock drifts, CPU utilization, memory usage, etc.) for significant statistical changes. Statistical changes may be identified by comparing system variables to prior values stored in the process historian. Based on statistical changes, alerts, alarms and historical data may be generated, recorded and/or disseminated by a user.

Volatile evidence preservation continuously records data as defined by the user (e.g., security expert) or set by a default. For example, specific instrumented data points are defined as sources of volatile evidence for forensic analysis. For the deployment mode 301, low level crypto functions (e.g., implemented in hardware by TPM/HSM) allow the volatile evidence to be authenticated (e.g., using TSP RFC 3161), signed and/or encrypted at the source to maintain chain-of-custody and to provide for secure transmittal.

Referring again to FIG. 2, at act 205, forensic data collection is deployed for the PLC. For example, the forensic data collection is performed in response to a security event being detected by the security monitoring application or based on analysis of the data collected by the security monitoring application.

In an embodiment, forensic data collection is performed by a forensic application. Forensic data collection may be performed by one or more devices, such as by an application running on the PLC, by an application running on a separate/neighboring PLC, and/or by an application running on separate/neighboring device, such as by an industrial personal computer (IPC) configured forensic data collection. The forensic application may be deployed before and/or after a security event is suspected, identified and/or confirmed/validated (e.g., post mortem). For example, after confirmation/validation of a security event, forensic data is collected, compiled and extracted from the PLC. Similar to the security monitoring application (as discussed above), the forensic data collection application performs volatile evidence preservation, maintains chain-of-custody and securely transmits the forensic data to a central service center (e.g., local or cloud server-based forensics platform, etc.). The forensic data collection application may perform similar functions to the security monitoring application, or the security monitoring application and the forensic application may be implemented together as a security monitoring and forensic application.

In addition to performing volatile evidence preservation, the forensic application may perform additional forensic functions, including a dynamic forensics runtime environment (e.g., a forensics support sandbox for cross-checking data validity between a live PLC and an emulated PLC), incoming connection monitoring and alerting, bootstrap emulation, etc. Additional and/or different forensic functions may be implemented. For example, a dynamic forensics support sandbox provides a framework allowing for safe injection of forensic runtime code (e.g., dynamic code injection from a live PLC) to facilitate the dynamic analysis of the security threat. The dynamic forensics support sandbox provides a forensic runtime environment allowing for safe (e.g., sandboxed, performance effect constrained, etc.) execution of simulated or emulated malware behavior to trigger or stimulate malicious dormant code on local or neighbor devices. Incoming connection monitoring and alerting provides for monitoring incoming connection attempts and scanning, and enables an output forensic data stream (e.g., a data shadow) for established network sockets (e.g., conceptual endpoints for communications) for forensic and dynamic analysis of the PLC data. Bootstrap emulation safely calls device initialization routines to stimulate dormant malware behavior without rebooting the device (e.g., stopping the production process, etc.). For example, most modern threats are designed to remain dormant and react to evade standard forensic steps. Bootstrap emulation stimulates the dormant threats by emulating the live process.

At act 207, an automated PLC security response operation is executed. For example, the automated response is performed in response to a security event detected by the security monitoring application, based on analyzing the data collected by the security monitoring application or based on data collected by the forensics application.

For example, the automated PLC security response operation may set the PLC to a safe state or revert the PLC to a previous configuration (e.g., before the security event). The automated PLC security response operation may set a production line to a safe speed or may safely stop the production line. In another example, the automated PLC security response operation executes a second function block upon detecting a changed first function block, replacing the changed function block. Other PLC code may be executed to replace compromised code, applications, etc., such as executing a new function chart to replace a changed function block.

In an embodiment, referring to deployment mode 301 of FIG. 3, the defined IoCs are used by the PLCs to automate security response actions, minimizing the adverse impacts of the detected cyber-attack. For example, when an IoC is detected, the PLC executes a routine to run the production line in a safe speed or stop the production line immediately in a safe mode. Additionally, the PLC may send an alarm message to the central service center, production operators, security professionals, etc. In another example, when a change to the signature of a function block (FB) is detected (e.g., an online or live change), the PLC may run another function block (FB) or function (FC) to replace the changed function block (FB). These methods can mitigate some detected malicious attacks and/or minimize their adverse impacts on the production and operation.

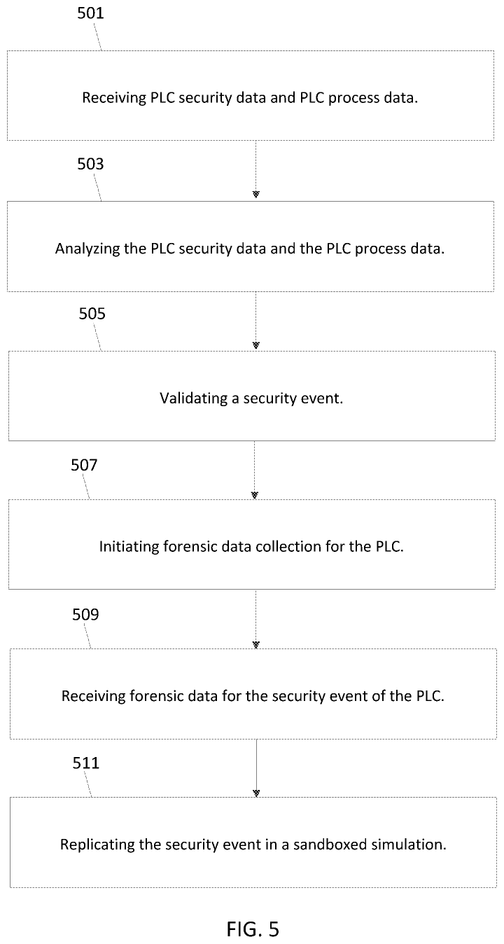

FIG. 5 illustrates a flowchart diagram of an embodiment of a method of monitoring a PLC. The method is implemented by the system of FIG. 6 (discussed below) and/or a different system. Additional, different or fewer acts may be provided. For example, acts 505-511 may be omitted. The method is provided in the order shown. Other orders may be provided and/or acts may be repeated. For example, acts 505-511 may be repeated for a plurality of security events. Further, acts 503-511 may be performed concurrently as parallel acts.

At act 501, PLC security data and PLC process data is received. For example, the data is received from a PLC monitoring application running on the PLC, running on a separate/neighboring PLC, on an industrial PC, or on another device in communication with the PLC. The PLC security data and PLC process data comprises PLC firmware data, PLC operating system data and PLC application data (e.g., data from different layers of the PLC architecture). Data may be received for a plurality of PLCs networked together in an industrial control system. The data is received for PLCs at idle and while running a live process.

In an embodiment, the PLC security data and PLC process data is received by server implementing a forensics environment. For example, PLC data collected by a security monitoring application may be exported and saved to an embedded historian in a security service center providing a forensic environment for cybersecurity forensics analysis. The security service center and forensic environment is provided on a networked local server, a cloud server or a combination thereof. The PLC security data and PLC process data, and the forensic environment, is made available to the user, such as via a remote process historian. For example, the forensic environment is accessible by a networked workstation, personal computer, laptop computer, tablet computer, mobile device, or other computing device, via a web portal.

In an embodiment, the forensic environment is provided on a cloud server for aggregating PLC data from multiple, unrelated industrial control systems (e.g., with a private big data cloud, cloud-based cyber security operation center, etc.). For example, an ICS-focused forensic environment is configured to access a process backbone of the industrial control system. The process backbone stores PLC and other industrial control data from all devices in the industrial control system, such as from existing process historians aggregated centrally. The forensic environment may collect data from the process backbone of multiple industrial control systems. The forensic environment may provide big data storage and an analytics infrastructure for fleet level benchmarking of industrial control systems and historical and trend analysis and data enrichment using the aggregated data from different industrial control systems. For example, using data analytics, the forensic environment identifies IoCs and IoAs common across industrial control systems and additional IoCs and IoAs specific to each industrial control system.

At act 503, the PLC security data and the PLC process data is analyzed. For example, the data is analyzed by a security monitoring application. The security monitoring application allows for anomaly/intrusion detection by monitoring the PLC before and after the anomaly/intrusion. The security monitoring application collects data relevant to monitoring and detecting ongoing incidents. The security monitoring application remains active before and after a suspected anomaly/intrusion. PLC data, including operating system (OS) instrumentation at the kernel level, filesystem metadata, security logs, data packet, data flow, etc. are inspected and analyzed for uncharacteristic patterns and the previously defined IoCs and IoAs. In an embodiment, the forensic environment monitors the received PLC security data and PLC process data, and maintains a timeline of the received data (e.g., data points from the PLC and process at idle, data points during various process acts, etc.). The timeline of received data may be used to directly compare data points from different points in time, and to identify data points that are out of range, inconsistent with outer data points or indicate uncharacteristic operations of the PLC and/or industrial control system. Previously stored data points may also be correlated to leverage the received data. For example, using data previously received and stored in forensic cloud security from different PLCs or other devices in the industrial control system, correlations are made between various data points and between data points and actual process variables (e.g., PLC inputs and outputs, sensor data, process settings, etc.). Correlations created by using the received data provide security analytics extending beyond merely monitoring security logs and PLC operations.

At act 505, a security event of the PLC is validated. For example, the security event is validated by security monitoring application and/or by the forensic environment based on the analyzing the received PLC security data and PLC process data. The security event is validated in real-time based on analyzing the data for the live process. In an embodiment, the forensic environment validates that a security event has occurred by identifying a deviation of received PLC security data or PLC process data from the fleet level benchmarks. For example, referring back to FIG. 4, a security event is identified when data received from the boot loader E is determined to outside of a normal range or inconsistent with the other monitored data points A-D and F. Other security events may also be identified in the same or different manner.

At act 507, forensic data collection for the PLC is initiated. For example, after a security event is validated, forensic data collection is initiated to collect forensic data from the PLC. The forensic data collection is performed to collect data indicative of the state of the PLC during and/or after the security event, and/or data indicative of the security event (e.g., virus, malware, security breach, etc.). The forensic data collection may be performed by a forensics application in order to maintain evidence of the cyber-attack, such as by maintaining chain-of-custody and providing additional information necessary in investigating the cyber-attacks. The forensics application may be installed after a suspicious event is confirmed, or installed in order to confirm a suspicious event. The forensics application supports the forensic analysis, and collects data as potential indicators of past anomalies/intrusions. The forensics application may only be active after a suspected anomaly/intrusion. The forensic data collection is initiated by the forensic environment, by the security monitoring application, manually by the user, etc. For example, in response to a security event detected by the monitoring device and/or the forensic environment, forensic data collection is initiated and performed on the PLC and/or the industrial control system using one or more forensics applications (e.g., installed on one or more PLCs).

At act 509, forensic data for the security event of the PLC is received. For example, the forensic data for the PLC and/or security event is collected, compiled and securely extracted for forensic analysis. For example, the forensic data is extracted or transmitted from the forensic application to the forensic environment. The forensics application maintains chain-of-custody for the forensic data, providing documentary evidence of the security event for use in investigating the event and/or in civil, criminal, or other proceedings regarding the security event.

At act 511, the security event is replicated in a sandboxed simulation. For example, the forensic application and/or the forensic environment replicates the PLC code in a runtime environment (e.g., a sandbox). Using the runtime environment, the PLC code is replicated incorporating data from PLC, such as received from the security monitoring and/or the forensic application. The sandboxed simulation may use real-time PLC and forensic data during a live process. The sandboxed simulation allows for detection and analysis of malware and other security threats. For example, for detecting threats on a live PLC and performing forensic analysis, a “clean” version of the live PLC code is emulated in the sandboxed simulation (e.g., an “emulated clean PLC”) to determine the expected behavior of the live PLC. Live production data from the live PLC and/or live sensor and other inputs to the live PLC are provided to the emulated clean PLC to determine the expected behavior based on what is currently being observed in the field. The expected behavior of the emulated clean PLC is compared to the actual behavior of the live PLC to detect and analyze the security threat. In the absence of malware or another security threat, the clean PLC and the live PLC will behave in the same manner (e.g., running the same firmware, software and control logic) and provide the same output at any given moment. Conversely, if malware or another security threat is active, the behavior and output of the live PLC will differ from the emulated clean PLC at any given moment, detecting the active security threat and providing additional information for the forensic analysis (e.g., a baseline of PLC without malware or another active security threat).

In an embodiment, the runtime environment quickly extracts and replicates the running process in a virtual environment for analysis. For example, referring to deployment mode 301 of FIG. 3, a copy of the virtual machines (VMs) are replicated using an imaged PLC (e.g., including PLC firmware, operating systems, configuration data, installed applications and all other data). The runtime environment may replicate multiple PLCs and emulate the process in the runtime environment for dynamic analysis. In this embodiment, live PLC data is continuously sent by the post-mortem forensic app (e.g., including production process data, memory blocks, and data from other ICS instrumentation). By receiving live PLC data, the emulation is performed in the sandbox environment as if it was still connected to the real process environment (e.g., based on extracted forensic data from the PLC). Using live PLC data evades mechanisms employed by modern malware programs to detect and bypass sandboxes (e.g., malware using context awareness, self-destruct/erase or other functionality). The runtime environment may be used to detect modern malware programs that deploy sophisticated security threats by maliciously and silently manipulating system configurations, running memory content, operating system and critical files, and/or firmware.

FIG. 6 illustrates an embodiment of a system for monitoring PLC operations. For example, system 600 includes instrumentation 601, server 605 and workstation 607 networked via network 603. Additional, different, or fewer components may be provided. For example, additional instrumentation 601, servers 605, networks 603, workstations 607 and/or PLCs 601E are used. In another example, the server 605 and the workstation 607 are directly connected, or implemented on a single computing device. In yet another example, the instrumentation 601 and the PLC 601E are implemented as a single PLC device.

Instrumentation 601 is configured to monitor and collect data from the PLC(s) 601E. For example, the instrumentation 601 includes a memory 601A configured to store monitoring application 601C and forensics application 601D. A processor 601D is configured to execute the monitoring application 601C and forensics application 601D to monitor and collect data from the PLC(s) 601E. For example, the processor 601B is configured to execute the security monitoring application 601C to collect data indicative of PLC(s) 601E operations and to execute the security forensics application 601D to perform non-intrusive forensic evidence collection. As discussed above with respect to FIG. 3, the instrumentation 601 may be configured as a PLC, or as an industrial PC, or as another device, or as a combination thereof.

For example, the instrumentation 601 is one of a plurality of PLCs. The PLC may be configured with memory 601C and the processor 601D for executing the security monitoring application 601C and the security forensics application 601D. The security monitoring application 601C and the security forensics application 601D collect data and forensic evidence from each of the plurality of PLCs 601E (e.g., including the PLC configured as instrumentation 601 and other PLCs 601E, such as neighbor legacy devices). In another example, the instrumentation 601 is an industrial personal computer (PC). In this example, the industrial PC is deployed locally at the control production/zone/cell network segment where the PLCs 601E are installed. The industrial PC is configured to execute the security monitoring application 601C and the security forensics application 601D to collect data and forensic evidence from a plurality of PLCs 601E. In yet another example, the instrumentation 601 is a PLC. In this example, the security monitoring application 601C and the security forensics application 601D are injectable firmware code stored in memory 601A and executed by processor 601B of the PLC. Additional and different implementations of instrumentation 601 may be provided.

Server 605 is configured to receive and analyze the data collected from the PLC(s) 601E. The server may be implemented as a cloud server, or a local server, or another server, or a combination thereof. The server 605 provides a forensics environment 605A. The forensics environment 605A is implemented as a forensics application providing a central service center for cybersecurity forensics analysis. The server 605 and forensics environment 605A receive PLC and other industrial control system data collected by the security monitoring application 601C and/or forensics application 601D of the instrumentation 601. In an embodiment, the server 605 is implemented as a cloud server that receives data from multiple PLCs in the same process environment and data from PLCs in many different and unrelated process environments. The forensics environment 605A uses the stored data from the different PLCs and analytics applied to the data from the different PLCs to generate fleet level benchmarking for process environments based on historical and trend analysis of the aggregated data from the different industrial control systems. For example, using data analytics, the forensic environment identifies/validates IoCs and IoAs common across different industrial control systems and additional IoCs and IoAs specific to each individual industrial control system.

Workstation 607 is configured to access server 605 and instrumentation 601 via network 603. For example, a user interface (such as a web portal) is provided via workstation 607 for accessing forensic environment 605A. The forensic environment is accessible by a networked workstation 607, such as a personal computer, laptop computer, tablet computer, mobile device, or other computing device. The workstation 607 includes a user interface and display. For example, the user interface may include one or more buttons, a keypad, a keyboard, a mouse, a stylist pen, a trackball, a rocker switch, a touch pad, voice recognition circuit, or another device or component for inputting data. The display may include an external monitor coupled to computer or server, or may be implemented as part of a laptop computer, tablet, mobile or other computing device. In an embodiment, the server 605 implemented as a local server computer, and the server 605 and the workstation 607 are implemented on the same device that includes a user interface and display.

Network(s) 603 is a wired or wireless network, or a combination thereof. Network 603 is configured as a local area network (LAN), wide area network (WAN), intranet, Internet or other now known or later developed network configurations. Any network or combination of networks for communicating between the instrumentation 601, PLC(s) 601E, workstation 607, server 605 and other components may be used. For example, multiple networks may be provided, such as one or more local plant networks (e.g., intranets) and one or more outward facing networks (e.g., the Internet). Other networks and combinations of networks may be provided.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A method of monitoring a programmable logic controller (PLC), the method comprising:
receiving (501), by a server implementing a forensic environment from a PLC monitoring application of the PLC or another PLC, PLC security data and PLC process data;
analyzing (503), by the server in the forensic environment, the PLC security data and the PLC process data;
validating (505), by the server in the forensic environment, a security event of the PLC based on the analyzing;
initiating (507), by the server with the forensic environment via a PLC forensics application, forensic data collection for the PLC; and
receiving (509), by the forensic environment of the server and from the PLC forensics application, forensic data for the security event of the PLC.

2. The method of claim 1, wherein the PLC security data and PLC process data is received for a plurality of PLCs, and
wherein fleet level benchmarks are determined for each of the plurality of PLCs based on the received PLC security data and PLC process data.

3. The method of claim 2, wherein validating (505) the security event comprises identifying a deviation of received PLC security data or PLC process data from the fleet level benchmarks.

4. The method of claim 1, wherein receiving (501) PLC security data and PLC process data comprises data for a live process, and
wherein the security event of the PLC based is validated (505) in real-time based on analyzing the data for the live process.

5. The method of claim 1, wherein the wherein the PLC security data and PLC process data comprises PLC firmware data, PLC operating system data and PLC application data.

6. The method of claim 1, wherein the PLC forensics application maintains chain-of-custody for the forensic data for the security event of the PLC.

7. The method of claim 1, further comprising:
replicating (511), by the forensic environment using received forensic data, the detected security event in a sandboxed simulation.

8. The method of claim 7, wherein the sandboxed simulation comprises using real-time forensic data received from the PLC forensics application during a live process.

9. A system for monitoring programmable logic controller (PLC) operations, the system comprising:
a memory (601A) configured to store a security monitoring application and a security forensics application; and
a processor (601B) configured to:
execute the security monitoring application (601C) to collect data indicative of PLC operations; and
execute the security forensics application (601D) to perform non-intrusive forensic evidence collection.

10. The system of claim 9, wherein the memory (601A) and the processor (601B) are configured as one of a plurality of PLCs (601, 601E), wherein executing the security monitoring application (601C) and the security forensics application (601D) comprises collecting data and forensic evidence from each of the plurality of PLCs (601E).

11. The system of claim 9, wherein the memory (601A) and the processor (601B) are configured as an industrial computer, wherein executing the security monitoring application (601C) and the security forensics application (601D) comprises collecting data and forensic evidence from a plurality of PLCs (601E).

12. The system of claim 9, wherein the memory (601A) and the processor (601B) are configured as a PLC (601), wherein the security monitoring application (601C) and the security forensics application (601D) comprise injectable application code.

13. A method of monitoring a programmable logic controller (PLC), the method comprising:
defining (201) a plurality of PLC operations for monitoring, the plurality of PLC operations indicative of a security event;
monitoring (203) the plurality of PLC operations, the monitoring comprising:
collecting data representative of the plurality of PLC operations, process data and PLC status;
analyzing the data for the security event; and
validating the security event; and
deploying (205), in response to the detected security event, forensic data collection for the PLC.

14. The method of claim 13, wherein monitoring (203) the plurality of PLC operations comprises monitoring PLC firmware operations, PLC operating system operations and PLC application operations.

15. The method of claim 13, further comprising:
exporting the collected data representative of the plurality of PLC operations and data of the forensic data collection for the PLC.

16. The method of claim 15, wherein the collected data representative of the plurality of PLC operations and data of the forensic data collection for the PLC is exported to a remote process historian.

17. The method of claim 13, further comprising:
executing (207), in response to the detected security event, an automated PLC security response operation.

18. The method of claim 17, wherein the automated PLC security response operation comprises setting a production line to a safe speed or stopping the production line in a safe mode.

19. The method of claim 17, wherein the automated PLC security response operation comprises executing, upon detecting a changed first function block, a second function block to replace the first function block.

20. The method of claim 17, wherein the automated PLC security response operation comprises executing, upon detecting a changed function block, a function chart to replace the function block.
